(19) United States
(12) Patent Application Publication
(10) Pub. No.: US 2016/0284091 A1
(43) Pub. Date: Sep. 29, 2016

(54) SYSTEM AND METHOD FOR SAFE SCANNING

(71) Applicant: Intel Corporation, Santa Clara, CA (US)

(72) Inventors: Nitin V. Sarangdhar, Portland, OR (US); Terry H. Pilsner, Hillsboro, OR (US)

(73) Assignee: Intel Corporation, Santa Clara, CA (US)

(21) Appl. No.: 14/672,054

(22) Filed: Mar. 27, 2015

(51) Int. Cl. G06T 7/00; G06K 9/00; G01B 11/14

(52) U.S. Cl. CPC G06T 7/0042; G01B 11/14; G06K 9/00604; G06K 9/00268

(57) ABSTRACT

Particular embodiments described herein provide for an electronic device that includes a distance detector that can determine a distance between the distance detector and an object and a scanner. The scanner is not activated if the distance is less than a predetermined distance. In one example, the object is a user and the scanner is an iris scanner.

### TECHNICAL FIELD

This disclosure relates in general to the field of electronic devices, and more particularly, to an electronic device for safe scanning.

### BACKGROUND

End users have more electronic device choices than ever before. A number of prominent technological trends are currently afoot (e.g., more computing devices, more detachable displays, more peripherals, etc.), and these trends are changing the electronic device landscape. One of the technological trends is the use of scanners for biometric identification purposes. However, some scanners have a minimum safe distance that must be observed.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating an embodiment of a safe scanning system in accordance with an embodiment of the present disclosure;

FIG. 2 is a simplified block diagram illustrating an embodiment of a safe scanning system in accordance with an embodiment of the present disclosure;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a simplified flowchart illustrating potential operations that may be associated with the communication system in accordance with an embodiment;

FIG. 6 is a block diagram illustrating an example computing system that is arranged in a point-to-point configuration in accordance with an embodiment;

FIG. 7 is a simplified block diagram associated with an example ARM ecosystem system on chip (SOC) of the present disclosure; and

FIG. 8 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

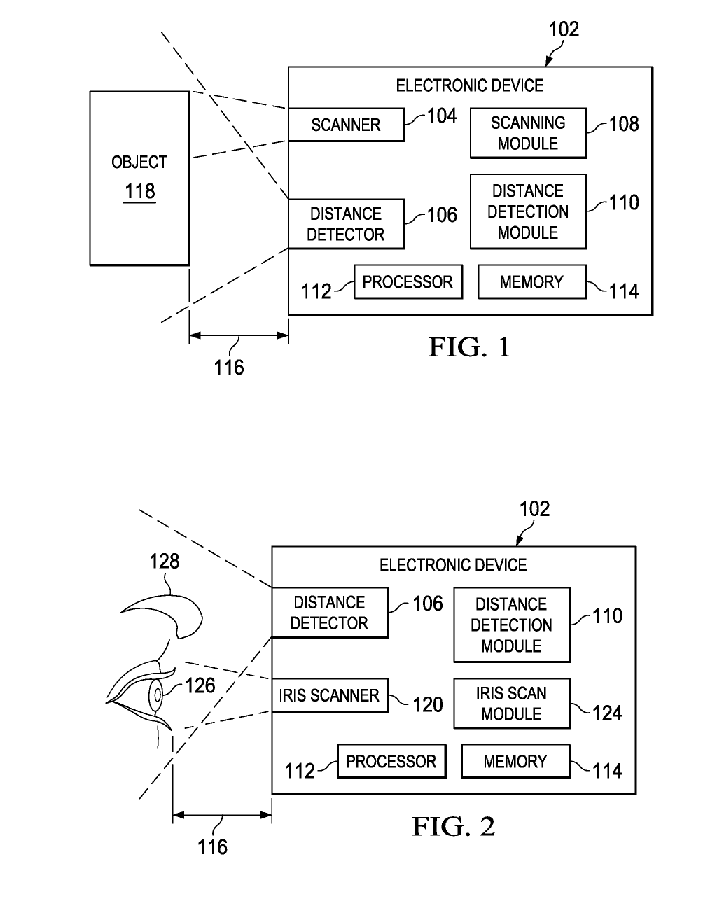

FIG. 1 is a simplified block diagram of an embodiment of an electronic device 102 in accordance with an embodiment of the present disclosure. Electronic device 102 can include a scanner 104, a distance detector 106, a scanning module 108, a distance detection module 110, a processor 112, and memory 114.

In example embodiments, electronic device 102 can be configured as a safe scanning device. For example, using distance detector 106, distance detection module 110 can determine a distance 116, that an object 118 is from electronic device 102. If distance 116 is below a minimum safe distance, scanning module 108 may not activate scanner 104 as a scan from scanner 104 would not be safe. In addition, if distance 116 is beyond an acceptable distance from electronic device 102, then scanning module 108 may not activate scanner 104 as a scan from scanner 104 would not produce acceptable results.

For purposes of illustrating certain example techniques of electronic device 102, it is important to understand some of details of the scanning environment. The following foundational information may be viewed as a basis from which the present disclosure may be properly explained.

Some of today's electronic devices include a scanner for identification or verification of a user or object. For example, an iris recognition or iris scan match is one method of biometric authentication that uses mathematical pattern-recognition techniques on images of one or both of the irises of an individual's eyes. The iris is a thin, circular structure in the eye, responsible for controlling the diameter and size of the pupil. An iris scan match typically uses an infrared imaging technique to improve quality of the captured image as minute details of unique complex random patterns in the iris are used for the biometric authentication. This approach requires an infrared illumination to illuminate the iris.

Persistent infrared illumination for a long period of time is harmful for human eye safety. There are guidelines established as per IEC 62471:2006-07 eye safety standard. These guidelines need to be used to determine a combination of minimum safe distance and a minimum operating time. The table below shows a representative calculation for a specific illumination.

| | | | |
|---|---|---|---|
| Minimum safe | Exempt Limit: safe for long exposure | 14.8 | cm |
| distance [cm] | Low Risk Limit: safe for <100 sec | 6.2 | cm |
| | Moderate Risk: safe for <10 sec | 2.6 | cm |

One of the current techniques of iris scanning depends upon ensuring that the infrared illumination is on for a maximum period of time (typically about thirty seconds) and then turning it off. This technique also expects that the user's eye is at a minimum safe distance away from the infrared illumination source. Most of the time the user will keep their eye at a distance from the infrared illumination. However there are occasions in which this may not be true and infrared illumination can be an eye safety hazard when it is repeatedly used or if the iris is too close to the infrared illumination. One solution used for infrared illumination is to use of lower power during low lighting conditions and normal power during normal lighting condition. The lower power of illumination increases the safe distance from the illumination but it also adds cost to the system in order to support two or more separate LED illumination controls. What is needed is a system and method by which infrared illumination is used in a safe manner.

An electronic device, as outlined in FIG. 1 can resolve these issues (and others). Electronic device 102 may be configured to provide a safe scanning environment through the use of a distance detector. A basic iris scan requires an infrared camera in order to capture a high resolution image of the iris. An infrared camera typically has a very narrow field of view and it is not desirable to activate an infrared camera unless there is a likelihood of a positive scan. A distance detector with a wide field of view can be used to capture and analyze a face of a user and features on the face may be used to determine a distance from the infrared camera and for hazard determination. The distance detector may be a visual distance detector, an infrared detector, a sonar detector, a proximity sensor that uses electromagnetic radiation, a capacitive detector or some other type of detector that can determine a distance to an object.

In an example, the distance detector can analyze a user's face and perform pattern recognition to determine facial features such as eyes, nose, facial outline, etc. Once two facial features are identified (e.g., two eyes), the number of pixels captured between those two facial features can be used to calculate the distance between the distance camera and the user. Face recognition algorithms have been shown to properly operate during different lighting conditions starting from pitch dark (around 10 lux) to sunlight (10000 lux). Based on the illumination from the infrared camera, a minimum safe distance from the infrared camera can be calculated. When the user comes closer to the minimum safe distance as determined by the distance detector, a trigger can be generated to turn off the infrared illumination from the infrared camera. This can help prevent a hazardous situation where an untrained or careless user inadvertently comes too close to the infrared camera. The system does not rely on proper human behavior and instead provides an automatic safety feature that is independent of the user.

In regards to the internal structure associated with electronic device 102, electronic device can include memory elements for storing information to be used in the operations outlined herein (e.g., minimum safe distances, predetermined times for how long to activate infrared scanner, etc.). Electronic device 102 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in electronic device 102 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

Additionally, electronic device 102 may include a processor that can execute software or an algorithm to perform activities as discussed herein. A processor can execute any type of instructions associated with the data to achieve the operations detailed herein. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.

Electronic device 102 may be a desktop computer, laptop computer, Internet of things (IoT) device, mobile device, personal digital assistant, smartphone, tablet, portable gaming device, remote sensor, Bluetooth radio, cell phone, etc. Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs. Electronic device 102 may include a configuration capable of transmission control protocol/Internet protocol (TCP/IP) communications for the transmission or reception of packets in a network. Electronic device 102 may also operate in conjunction with a user datagram protocol/IP (UDP/IP) or any other suitable protocol where appropriate and based on particular needs.

In one example, electronic device 102 can operate in any type or topology of networks. A network represents a series of points or nodes of interconnected communication paths for receiving and transmitting packets of information that propagate through the network. The network offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In an example, electronic device 102 can send and receive, network traffic, which is inclusive of packets, frames, signals, data, etc., according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in electronic device 102. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

Turning to FIG. 2, FIG. 2 is a simplified block diagram of an embodiment of electronic device 102 in accordance with an embodiment of the present disclosure. Electronic device 102 can include distance detector 106, distance detection module 110, a processor 112, memory 114, an iris scanner 120, and an iris scan module 124. In use, distance detector 106 can be configured to calculate distance 116 of an eye 126 of a user 128. If the distance is a safe distance, then iris scanner 120 can be activated to scan eye 126 and obtain an iris scan of user 128. The scan of eye 126 can then be used by iris scan module 124 for biometric authentication.

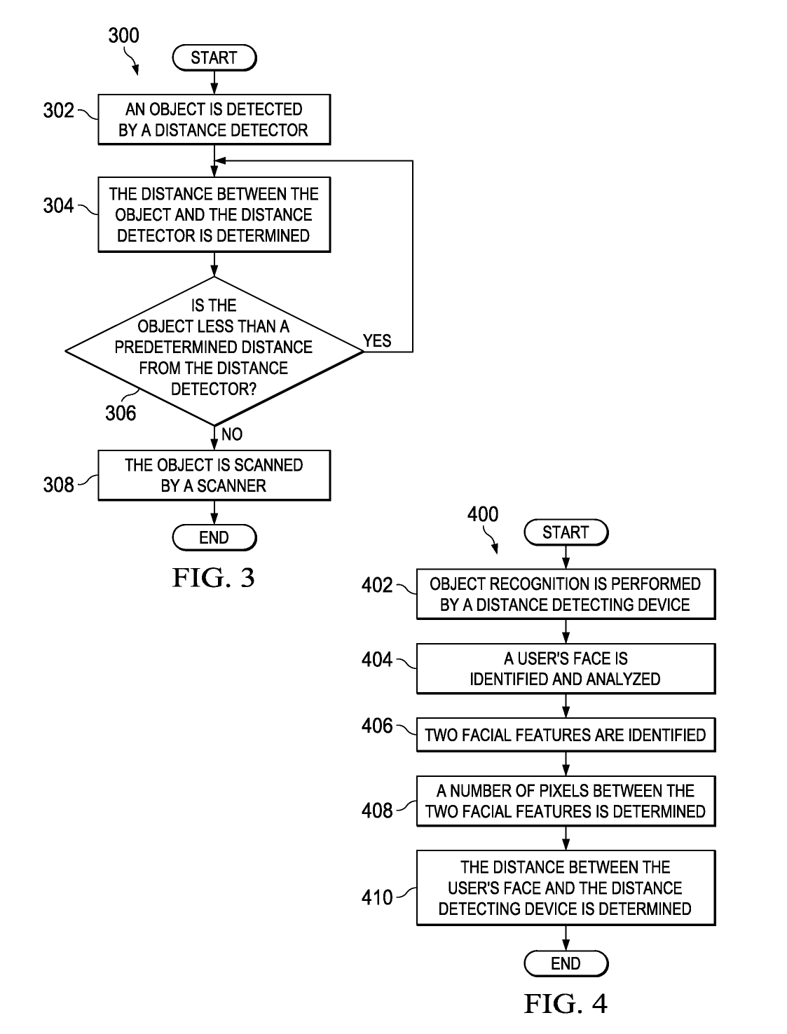

Turning to FIG. 3, FIG. 3 is a simplified flowchart 300 illustrating potential operations that may be associated with the communication system in accordance with an embodiment. At 302, an object is detected by a distance detector. At 304, the distance between the object and the distance detector is determined. At 306, the system determines if the object is less than a predetermined distance from the distance detector. If the object is not less than the predetermined distance from the distance detector, then the object is scanned by a scanner, as in 308. If the object is less than the predetermined distance from the distance detector, then, the object may not be a safe distance from the scanner, and the distance between the object and the distance detector is determined again. This may repeat several times until the object is determined to be a safe distance from the scanner.

Turning to FIG. 4, FIG. 4 is a simplified flowchart 400 illustrating potential operations that may be associated with the communication system in accordance with an embodiment. At 402, object recognition is performed by a distance detecting device. At 404, a user's face is identified and analyzed. At 406, two facial features are identified. At 408, a number of pixels between the two facial features is determined. At 410, a distance between the user's face and the distance detecting device is determined. By determining the distance between the distance detecting device and the user's face, the system can ensure that the user's face is a minimum safe distance from a scanner.

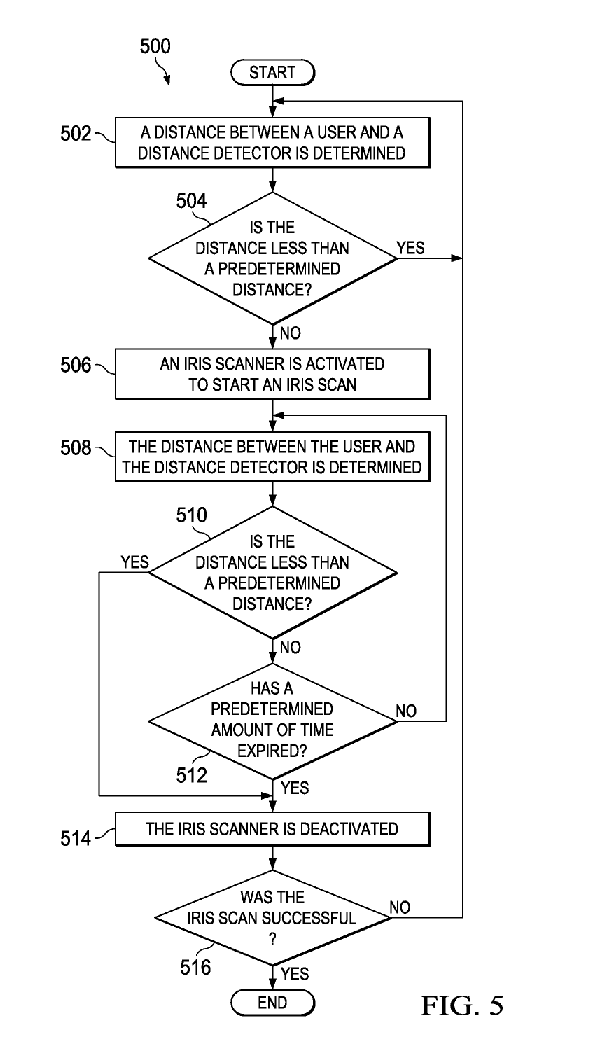

Turning to FIG. 5, FIG. 5 is a simplified flowchart 500 illustrating potential operations that may be associated with the communication system in accordance with an embodiment. At 502, a distance between a user and a distance detector is determined. At 504, the system determines if the distance is less than a predetermined distance. If the distance is less than a predetermined distance, then the distance between the user and the distance detector is determined again, as in 502. This can be repeated until the user is determined to be a safe distance from the distance detector.

If the distance is not less than a predetermined distance, then an iris scanner is activated to start an iris scan, as in 506. At 508, the distance between the user and the distance detector is again determined. At 510, the system determines if the distance is less than a predetermined distance. This is determined while the iris scanner is activated because a user could accidently move too close to the iris scanner while it was running and potentially damage their eye. If the distance is less than a predetermined distance, then the iris scanner is deactivated, as in 514. The predetermined distance may be the same predetermined distance as in 504 or may be a different distance.

At 516, the system determines if the iris scan was successful. If the iris scan was successful, then the process ends and the iris scan can be analyzed and interpreted, stored, or some other activity or process. If the iris scan was not successful, then another scan may be attempted and the system can determine if the distance between the user and the distance detector is less than a predetermined distance, as in 504.

Going back to 510, while the iris scan is running, the system determines if the distance is less than a predetermined distance. If the distance is not less than a predetermined distance, then the system determines if a predetermined amount of time has expired, as in 512. Iris scans typically take about three to five seconds and it would be inefficient and in some instances unsafe to keep the iris scan, or any other scanner, on longer than is necessary. If the predetermined amount of time has not expired, then the system goes back to 508 where the distance between the user and the distance detector is again determined and for safety, at 510, the system determines if the distance is less than a predetermined distance. If the predetermined amount of time has expired, then then the iris scanner is deactivated, as in 514.

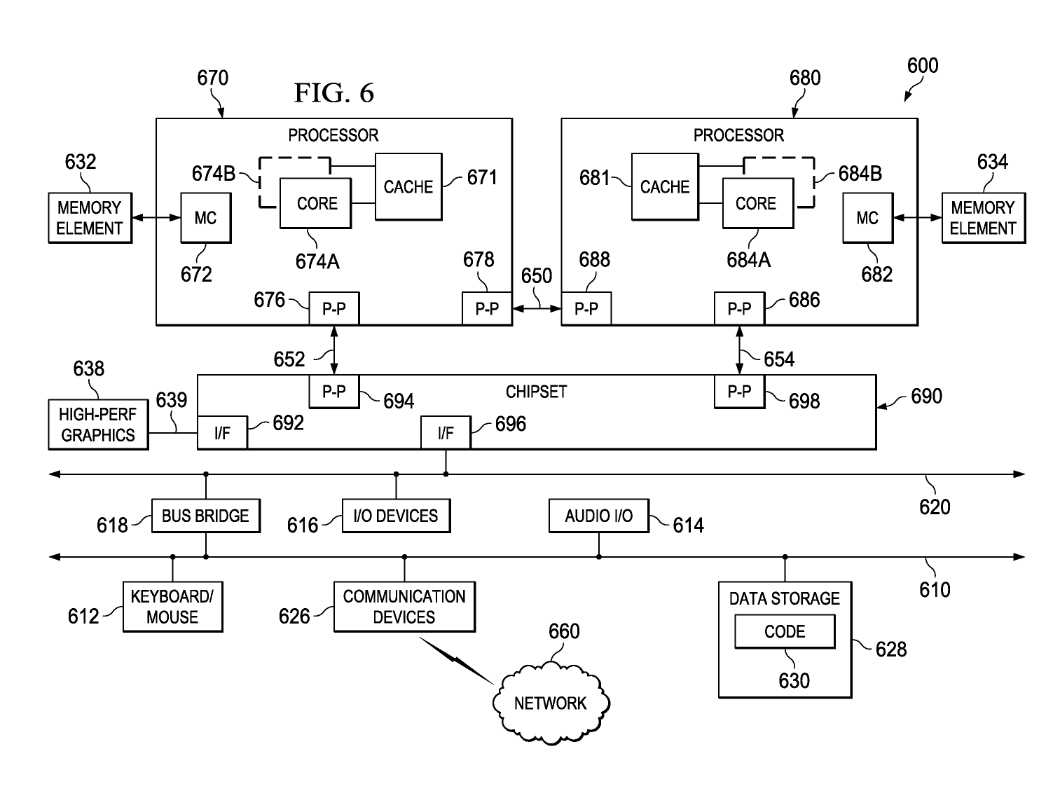

FIG. 6 illustrates a computing system 600 that is arranged in a point-to-point (PtP) configuration according to an embodiment. In particular, FIG. 6 shows a system where processors, memory, and input/output devices are interconnected by a number of point-to-point interfaces. Generally, one or more of the network elements of electronic device 100a may be configured in the same or similar manner as computing system 600.

As illustrated in FIG. 6, system 600 may include several processors, of which only two, processors 670 and 680, are shown for clarity. While two processors 670 and 680 are shown, it is to be understood that an embodiment of system 600 may also include only one such processor. Processors 670 and 680 may each include a set of cores (i.e., processor cores 674A and 674B and processor cores 684A and 684B) to execute multiple threads of a program. The cores may be configured to execute instruction code in a manner similar to that discussed above with reference to FIGS. 2-6. Each processor 670, 680 may include at least one shared cache 671, 681. Shared caches 671, 681 may store data (e.g., instructions) that are utilized by one or more components of processors 670, 680, such as processor cores 674 and 684.

Processors 670 and 680 may also each include integrated memory controller logic (MC) 672 and 682 to communicate with memory elements 632 and 634. Memory elements 632 and/or 634 may store various data used by processors 670 and 680. In alternative embodiments, memory controller logic 672 and 682 may be discrete logic separate from processors 670 and 680.

Processors 670 and 680 may be any type of processor, and may exchange data via a point-to-point (PtP) interface 650 using point-to-point interface circuits 678 and 686, respectively. Processors 670 and 680 may each exchange data with a control logic 690 via individual point-to-point interfaces 652 and 654 using point-to-point interface circuits 676, 686, 694, and 696. Control logic 690 may also exchange data with a high-performance graphics circuit 638 via a high-performance graphics interface 639, using an interface circuit 692, which could be a PtP interface circuit. In alternative embodiments, any or all of the PtP links illustrated in FIG. 6 could be implemented as a multi-drop bus rather than a PtP link.

Control logic 690 may be in communication with a bus 620 via an interface circuit 696. Bus 620 may have one or more devices that communicate over it, such as a bus bridge 618 and I/O devices 616. Via a bus 610, bus bridge 618 may be in communication with other devices such as a keyboard/mouse 612 (or other input devices such as a touch screen, trackball, etc.), communication devices 626 (such as modems, network interface devices, or other types of communication devices that may communicate through a computer network 660), audio I/O devices 614, and/or a data storage device 628. Data storage device 628 may store code 630, which may be executed by processors 670 and/or 680. In alternative embodiments, any portions of the bus architectures could be implemented with one or more PtP links.

The computer system depicted in FIG. 6 is a schematic illustration of an embodiment of a computing system that may be utilized to implement various embodiments discussed herein. It will be appreciated that various components of the system depicted in FIG. 6 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

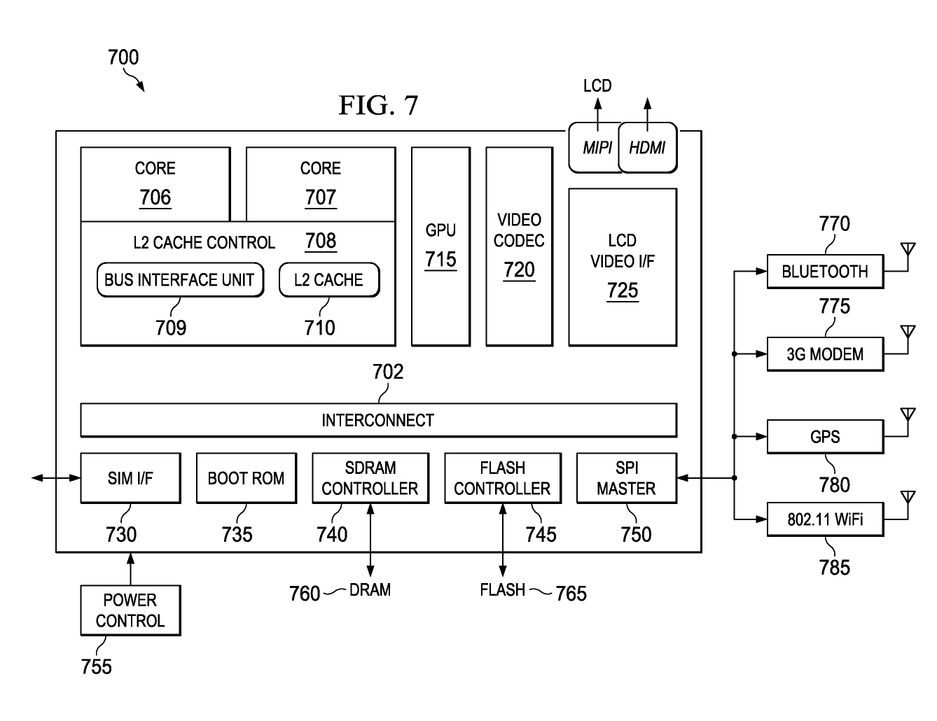

Turning to FIG. 7, FIG. 7 is a simplified block diagram associated with an example ARM ecosystem SOC 700 of the present disclosure. At least one example implementation of the present disclosure can include the data rating features discussed herein and an ARM component. For example, the example of FIG. 7 can be associated with any ARM core (e.g., A-9, A-15, etc.). Further, the architecture can be part of any type of tablet, smartphone (inclusive of Android™ phones, iPhones™, iPad™ Google Nexus™, Microsoft Surfacer™, personal computer, server, video processing components, laptop computer (inclusive of any type of notebook), Ultrabook™ system, any type of touch-enabled input device, etc.

In this example of FIG. 7, ARM ecosystem SOC 700 may include multiple cores 706-707, an L2 cache control 708, a bus interface unit 709, an L2 cache 710, a graphics processing unit (GPU) 715, an interconnect 702, a video codec 720, and a liquid crystal display (LCD) I/F 725, which may be associated with mobile industry processor interface (MIPI)/high-definition multimedia interface (HDMI) links that couple to an LCD.

ARM ecosystem SOC 700 may also include a subscriber identity module (SIM) I/F 730, a boot read-only memory (ROM) 735, a synchronous dynamic random access memory (SDRAM) controller 740, a flash controller 745, a serial peripheral interface (SPI) master 750, a suitable power control 755, a dynamic RAM (DRAM) 760, and flash 765. In addition, one or more embodiments include one or more communication capabilities, interfaces, and features such as instances of Bluetooth™ 770, a 3G modem 775, a global positioning system (GPS) 780, and an 802.11 Wi-Fi 785.

In operation, the example of FIG. 7 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe™ Flash™ Player, Java Platform Standard Edition (Java SE), JavaFX, Linux, Microsoft Windows Embedded, Symbian and Ubuntu, etc.). In at least one embodiment, the core processor may implement an out-of-order superscalar pipeline with a coupled low-latency level-2 cache.

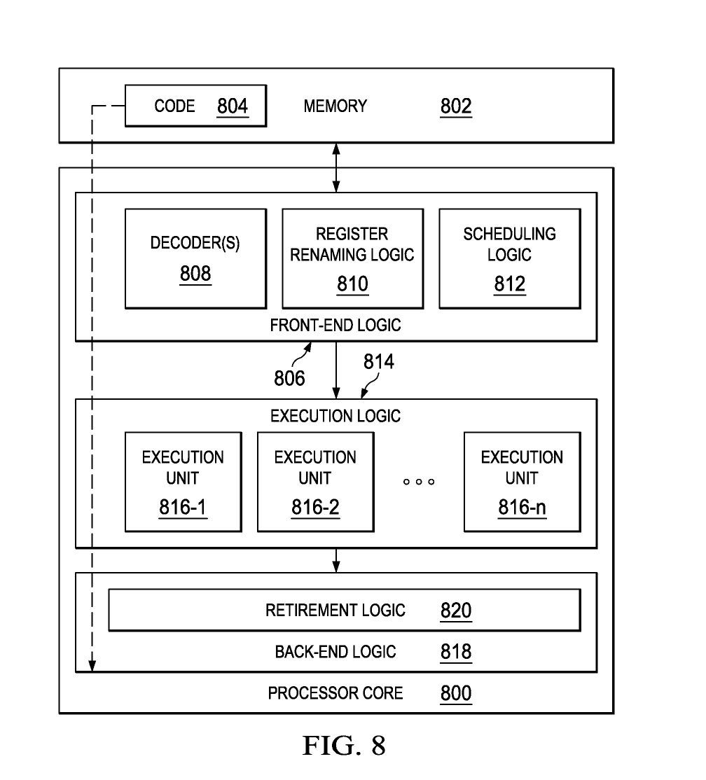

FIG. 8 illustrates a processor core 800 according to an embodiment. Processor core 8 may be the core for any type of processor, such as a micro-processor, an embedded processor, a digital signal processor (DSP), a network processor, or other device to execute code. Although only one processor core 800 is illustrated in FIG. 8, a processor may alternatively include more than one of the processor core 800 illustrated in FIG. 8. For example, processor core 800 represents an embodiment of processors cores 674a, 674b, 684a, and 684b shown and described with reference to processors 670 and 680 of FIG. 6. Processor core 800 may be a single-threaded core or, for at least one embodiment, processor core 800 may be multithreaded in that it may include more than one hardware thread context (or “logical processor”) per core.

FIG. 8 also illustrates a memory 802 coupled to processor core 800 in accordance with an embodiment. Memory 802 may be any of a wide variety of memories (including various layers of memory hierarchy) as are known or otherwise available to those of skill in the art. Memory 802 may include code 804, which may be one or more instructions, to be executed by processor core 800. Processor core 800 can follow a program sequence of instructions indicated by code 804. Each instruction enters a front-end logic 806 and is processed by one or more decoders 808. The decoder may generate, as its output, a micro operation such as a fixed width micro operation in a predefined format, or may generate other instructions, microinstructions, or control signals that reflect the original code instruction. Front-end logic 806 also includes register renaming logic 810 and scheduling logic 812, which generally allocate resources and queue the operation corresponding to the instruction for execution.

Processor core 800 can also include execution logic 814 having a set of execution units 816-1 through 816-N. Some embodiments may include a number of execution units dedicated to specific functions or sets of functions. Other embodiments may include only one execution unit or one execution unit that can perform a particular function. Execution logic 814 performs the operations specified by code instructions.

After completion of execution of the operations specified by the code instructions, back-end logic 818 can retire the instructions of code 804. In one embodiment, processor core 800 allows out of order execution but requires in order retirement of instructions. Retirement logic 820 may take a variety of known forms (e.g., re-order buffers or the like). In this manner, processor core 800 is transformed during execution of code 804, at least in terms of the output generated by the decoder, hardware registers and tables utilized by register renaming logic 810, and any registers (not shown) modified by execution logic 814.

Although not illustrated in FIG. 8, a processor may include other elements on a chip with processor core 800, at least some of which were shown and described herein with reference to FIG. 8. For example, as shown in FIG. 8, a processor may include memory control logic along with processor core 800. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 80 and its teachings are readily scalable and can accommodate a large number of components, as well as more complicated/sophisticated arrangements and configurations. Accordingly, the examples provided should not limit the scope or inhibit the broad teachings of electronic device 100a-100c as potentially applied to a myriad of other architectures.

It is also important to note that the operations in the preceding diagrams illustrate only some of the possible correlating scenarios and patterns that may be executed by, or within, communication systems 100a-100c. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by electronic device 100a in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although electronic device 100a has been illustrated with reference to particular elements and operations that facilitate the communication process, these elements and operations may be replaced by any suitable architecture, protocols, and/or processes that achieve the intended functionality of electronic device 100a. As used herein, the term “and/or” is to include an and or an or condition. For example, A, B, and/or C would include A, B, and C; A and B; A and C; B and C; A, B, or C; A or B; A or C; B or C; and any other variations thereof.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### Other Notes and Examples

Example A1 is an apparatus that includes a distance detector that can determine a distance between the distance detector and an object, and a scanner, wherein the scanner is not activated if the distance is less than a predetermined distance.

In Example A2, the subject matter of Example A1 may optionally include where the scanner is an iris scanner.

In Example A3, the subject matter of any of the preceding ‘A’ Examples can optionally include where while the scanner is activated, the distance between the distance detector and the object continues to be determined and the scanner is deactivated if the distance is less than the predetermined distance.

In Example A4, the subject matter of any of the preceding ‘A’ Examples can optionally include where the object is a user.

In Example A5, the subject matter of any of the preceding ‘A’ Examples can optionally include where the distance detector identifies at least two facial features on a user and uses the at least two facial features to determine the distance.

In Example A6, the subject matter of any of the preceding ‘A’ Examples can optionally include where the scanner is a biometric authentication scanner.

Example C1 is at least one machine readable storage medium having one or more instructions that when executed by at least one processor cause the at least one processor to determine a distance between a distance detector and an object and activate a scanner if the distance is less than a predetermined distance.

In Example C2, the subject matter of Example C1 can optionally include where the scanner is an iris scanner.

In Example C3, the subject matter of any one of Examples C1-C2 can optionally include one or more instructions that when executed by the at least one processor cause the at least one processor to repeatedly determine the distance between the distance detector and the object while the scanner is activated and deactivate the scanner is if the distance is less than the predetermined distance.

In Example C4, the subject matter of any one of Examples C1-C3 can optionally include where the object is a user.

In Example C5, the subject matter of any one of Examples C1-C4 can optionally include one or more instructions that when executed by the at least one processor cause the at least one processor to identify at least two facial features on a user and use the at least two facial features to determine the distance.

Example M1 is a method that includes determining a distance between a distance detector and an object and activating a scanner if the distance is less than a predetermined distance.

In Example M2, the subject matter of any of the preceding ‘M’ Examples can optionally include where the scanner is an iris scanner.

In Example M3, the subject matter of any of the preceding ‘M’ Examples can optionally include repeatedly determining the distance between the distance detector and the object while the scanner is activated and deactivating the scanner is if the distance is less than the predetermined distance.

In Example M4, the subject matter of any of the preceding ‘M’ Examples can optionally include where the object is a user.

In Example M5, the subject matter of any of the preceding ‘M’ Examples can optionally include identifying at least two facial features on a user and using the at least two facial features to determine the distance.

Example S1 is a system that includes a distance detection module configured for determining a distance between a distance detector and an object and activating a scanner if the distance is less than a predetermined distance.

In Example S2, the subject matter of ‘S1’ can may optionally include where the scanner is an iris scanner.

In Example S3, the subject matter of any of the preceding ‘SS’ Examples can optionally include where the distance detection module is further configured for repeatedly determining the distance between the distance detector and the object while the scanner is activated and deactivating the scanner is if the distance is less than the predetermined distance.

In Example S4, the subject matter of any of the preceding ‘SS’ Examples can optionally include where the object is a user and the distance detector identifies at least two facial features on the user and uses the at least two facial features to determine the distance.

Example X1 is a machine-readable storage medium including machine-readable instructions to implement a method or realize an apparatus as in any one of the Examples A1-A6 and M1-M5. Example Y1 is an apparatus comprising means for performing of any of the Example methods M1-M5. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. An apparatus comprising:
a distance detector, wherein the distance detector is configured to determine a distance between the distance detector and an object; and
a scanner, wherein the scanner is not activated if the distance is less than a predetermined distance.

2. The apparatus of claim 1, wherein the scanner is an iris scanner.

3. The apparatus of claim 1, wherein while the scanner is activated, the distance between the distance detector and the object continues to be determined and the scanner is deactivated if the distance is less than the predetermined distance.

4. The apparatus of claim 1, wherein the object is a user.

5. The apparatus of claim 1, wherein the distance detector identifies at least two facial features on a user and uses the at least two facial features to determine the distance.

6. The apparatus of claim 1, wherein the scanner is a biometric authentication scanner.

7. At least one machine readable storage medium comprising one or more instructions that when executed by at least one processor, cause the processor to:
determine a distance between a distance detector and an object; and
activate a scanner if the distance is less than a predetermined distance.

8. The at least one machine readable storage medium of claim 7, wherein the scanner is an iris scanner.

9. The at least one machine readable storage medium of claim 7, comprising one or more instructions that when executed by the at least one processor, cause the processor to:
repeatedly determine the distance between the distance detector and the object while the scanner is activated; and
deactivate the scanner is if the distance is less than the predetermined distance.

10. The at least one machine readable storage medium of claim 7, wherein the object is a user.

11. The at least one machine readable storage medium of claim 7, comprising one or more instructions that when executed by the at least one processor, cause the processor to:
identify at least two facial features on a user and use the at least two facial features to determine the distance.

12. A method comprising:
determining a distance between a distance detector and an object; and
activating a scanner if the distance is less than a predetermined distance.

13. The method of claim 12, wherein the scanner is an iris scanner.

14. The method of claim 12, further comprising:
repeatedly determining the distance between the distance detector and the object while the scanner is activated; and
deactivating the scanner is if the distance is less than the predetermined distance.

15. The method of claim 12, wherein the object is a user.

16. The method of claim 12, further comprising:
identifying at least two facial features on a user; and
using the at least two facial features to determine the distance.

17. A system comprising:
an distance detection module configured for:
determining a distance between a distance detector and an object; and
activating a scanner if the distance is less than a predetermined distance.

18. The system of claim 17, wherein the scanner is an iris scanner.

19. The system of claim 17, wherein the distance detection module is further configured for:
repeatedly determining the distance between the distance detector and the object while the scanner is activated; and
deactivating the scanner is if the distance is less than the predetermined distance.

20. The system of claim 17, wherein the object is a user and the distance detector identifies at least two facial features on the user and uses the at least two facial features to determine the distance.
